(19) United States
(12) Patent Application Publication
(10) Pub. No.: US 2017/0165581 A1
(43) Pub. Date: Jun. 15, 2017

(54) FANTASY SPORTS TECHNIQUES AND SYSTEMS

(71) Applicant: Hubstar, Inc., Austin, TX (US)

(72) Inventors: Thomas A. McAuley, Austin, TX (US); Andrew K. Baldacci, Bangor, ME (US); Julien Collard-Seguin, Dorchester, MA (US); Mark Brenner, Summit, NJ (US)

(73) Assignee: Hubstar, Inc., Austin, TX (US)

(21) Appl. No.: 15/299,442

(22) Filed: Oct. 20, 2016

Related U.S. Application Data
(60) Provisional application No. 62/244,179, filed on Oct. 20, 2015.
(60) Provisional application No. 62/410,825, filed on Oct. 20, 2016.

(51) Int. Cl. A63F 13/828; A63F 13/34; A63F 13/32; A63F 13/335; A63F 13/67; A63F 13/65

(52) U.S. Cl. CPC A63F 13/828; A63F 13/67; A63F 13/65; A63F 13/32; A63F 13/335; A63F 13/34; A63F 2300/8052

(57) ABSTRACT

A method of administering a fantasy sports contest may include steps of: obtaining a target score for the fantasy sports contest; identifying a prize corresponding to the target score; receiving input specifying a lineup of a fantasy sports team of a participant in the fantasy sports contest; determining an actual score of the lineup of the participant's team; and determining whether the actual score of the participant's lineup exceeds the target score, and if the actual score of the participant's lineup exceeds the target score, providing an indication that the prize has been awarded to the participant. The target score may depend on statistical measures and/or probability distributions of predicted scores of one or more lineups eligible for the fantasy sports contest, or a value of the prize may depend on statistical measures and/or a probability distribution of a predicted score of the lineup of the participant's team.

### CROSS-REFERENCE TO RELATED APPLICATIONS

This application claims priority to and benefit of U.S. Provisional Patent Application No. 62/244,179, titled “Fantasy Sports Techniques and Systems” and filed on Oct. 20, 2015 under Attorney Docket No. HSG-002PR, and claims priority to and benefit of U.S. Provisional Patent Application No. 62/410,825, titled “Fantasy Sports Techniques and Systems” and filed on Oct. 20, 2016 under Attorney Docket No. HSG-002PR2; each of the foregoing applications is hereby incorporated by reference herein in its entirety.

### FIELD OF INVENTION

The present disclosure relates generally to techniques and systems for operating fantasy sports competitions.

### BACKGROUND

Fantasy sports is an increasingly popular activity in which users select (or “draft”) real world individuals (or “players”), most commonly professional athletes, to form a fantasy sports team. The performance of the real world players that make up the user's fantasy sports team determines the performance of the user's fantasy sports team. Below is an example of how some fantasy sports contests work for football.

The roster for a typical fantasy football team might include the following positions to make up the team's “starting lineup”: 1 Quarterback (“QB”), 2 Running Backs (“RB”), 2 Wide Receivers (“WR”), 1 Tight End (“TE”), 1 Kicker (“K”), and 1 Defense (“DEF”). The exact makeup of a fantasy football roster may vary depending on the host site or fantasy sports contest. For example, some host sites may also include a Flex position, which could be filled, for example, by a Running Back, Wide Receiver, or Tight End. Also, some host sites or contests may include a bench, which is a set of players that can be moved in and out of the starting lineup.

When a user drafts their fantasy football team, they select real world football players to fill each position on the roster. Typically, the pool of available players are all from the same league (e.g., the National Football League). There are several methods of drafting a team (or “draft formats”). Two of the most popular draft formats are “Snake” and “Salary Cap”.

In the Snake format, each user in the fantasy sports league is given a pick number. For the sake of this example, let us assume that a user's draft number is 1, which means the user has the first pick in the draft. In this case the user may select any individual from the available pool of players. In the Snake format, once a player is selected, no other user may select that player. As an example, if the user with the first pick selected Tom Brady to fill the Quarterback position, the user with the second pick would be allowed to select any other individual from the pool of available players, except Tom Brady. As a result, in the Snake format, no two fantasy sports teams are allowed to select the same player. The snake format is typically used for leagues or contests that have a small number of participating teams (typically 2-16 teams). Other draft formats in which no two teams can select the same player are possible, including linear drafts and auction drafts.

In the Salary Cap format, every individual within the pool of available players is assigned a price by the contest's operator. For example, Tom Brady might be assigned a price of $10,000. Users are then given a budget (e.g., $50,000) to be used to draft their team. Users generally must select a player to fill every position on their roster without exceeding the set budget. Prices for individual players and budgets for drafting teams may vary depending on the host site or league. Note that the player prices and team budgets are for gameplay purposes only; no actual money is exchanged between the user and host site for the purposes of the Salary Cap draft format. In the Salary Cap format, there are no restrictions on the number of teams that can have any individual player or combination of players on their roster. For example, multiple teams may select both Tom Brady and Dez Bryant. The Salary Cap format is typically used for leagues or contests that have a large number of participating teams.

Note that the above details two of the more popular there draft formats. However, there may be other formats or methods for assembling a fantasy sports teams offered by certain host sites or leagues.

Once the user has drafted his or her team, the team may begin participating in the contest or league. As mentioned above, the user's team's performance is dependent on the real world performance of the players that make up the user's team's roster, specifically the team's starting lineup, during a set period of time. The contest or league duration may vary depending on the operator's preferences or the league's settings. For example, some contests or leagues may last for an entire season (e.g., for the entirety of NFL Regular Season), while others may only last for one day. For the purposes of this example, lets reference the typical duration for a popular daily fantasy football contest. A typical daily fantasy football contest will have a duration of 1 week. Let's use “Week 1” of the NFL's Regular season schedule as an example. For a typical Week 1 contest, users would be required to draft their team prior to the start of Week 1. The user's team would then accumulate points based on the performance of the players in their starting lineup in any real world game that is played during Week 1 of the NFL Season.

To determine how many points a fantasy sports team can score, real world performance metrics are given a value by the operator or league. The performance metrics and their associated values are set prior to the start of the contest or league and may vary depending on the operator's preferences or the league's settings. For example, a Rushing Touchdown may be worth 6 points and every 10 yards Rushing accumulated by a Running Back may be worth 1 point. Using this example, if a user's team's starting lineup included Adrian Peterson and, during the Minnesota Vikings Week 1 game, Adrian Peterson ran for 110 Yards and 2 Touchdowns, the user's team would be awarded 23 fantasy points (2×6+11×1). Note that some host sites or leagues may award fractional points. For example, if Adrian Peterson ran for 108 Yards and 2 Touchdowns, the user's fantasy team may be awarded 22.8 points (2×6+10.8×1). The sum of the points scored by each player in the user's starting lineup equals the total points awarded to the user's fantasy sports team. As an example, if a user had the following starting lineup and associated points for each player, for a Week 1 daily fantasy football contest, the user's team would have achieved 109 total fantasy points.

QB: Tom Brady, 28 points

RB: Adrian Peterson, 23 points

RB: Joseph Randle, 8 points

WR: Dez Bryant, 13 points

WR: AJ Green, 15 points

TE: Jimmy Graham, 6 points

K: Mason Crosby, 7 points

DEF: New England Patriots, 9 points

As mentioned, the number of fantasy points scored by a user's team during the contest or league duration will determine the user's team's performance. In current fantasy sports offerings, fantasy sports teams compete against each other during the duration of the contest or league. There are several different formats in which fantasy sports teams compete against each other. The formats may vary depending on the operator's preferences or the league's settings. In the traditional season long format, which typically involves a Snake Draft or auction draft, a user's team is matched up against one other team in the contest or league. Teams then accumulate a record throughout the season and are ranked based on their record amongst the other teams in the contest or league. For example, let's say Team A is matched up against Team B in Week 1 of the NFL Season. During Week 1, Team A scores a total of 112 points and Team B scores a total of 97 points. In this example, Team A would be determined to be the winner of this matchup and would have a contest/league record of 1-0 (or 1 Win and 0 Losses), and Team B would have a contest/league record of 0-1 (or 0 Wins and 1 Loss). Team A and Team B would then be ranked in the contest or league based on their record. Team A and Team B would be matched up against different teams in Week 2. Typically, in this format, there is a contest or league playoff. At the end of the contest or leagues regular season a certain number of teams (e.g., 4 teams) with the best record enter into a knockout style playoff to determine the winner of the contest or league.

Another popular contest or league format is daily fantasy “pools”, which most often include a Salary Cap based draft. In this format, all of the teams in the contest or league may play against each other. The number of teams in a daily fantasy sports contest or league generally varies anywhere from 2 teams up to as many as hundreds of thousands of teams. In this format, a team may be ranked against all other teams based on the number of points that the team scores during the contest or league duration. For example, a user that enters a NFL Week 1 fantasy contest and drafts a team that scores 103 points may be ranked against all other teams in the contest. The team that scores the most points would be declared the winner of the contest.

In recent years, daily fantasy sports has become an increasingly popular activity. Many daily fantasy sports contests require the user to pay an entry fee for each team that the user enters into the contest. For these pay-to-play contests, cash prizes are awarded to a certain number of teams based on their final ranking in the contest. These prizes are guaranteed by the host site operator and are determined before the start of the contest. The specific details of a fantasy sports contest (number of entries, entry fee amount, and prize structure) may vary depending on the host site. An example of a daily fantasy sports contest is DraftKings' “Millionaire Maker”. This contest for Week 5 of the NFL Regular Season allows up to 400,750 teams to enter. The entry fee for each team is $20 and the prize structure is detailed below:

1st Place gets $1,200,000

2nd Place gets $500,000

3rd Place gets $250,000

. . . etc.

47,001st through 88,500th get $30

### SUMMARY OF THE INVENTION

As is described above, there are many different ways that exist for users to participate in fantasy sports. However, for all conventional fantasy sports offerings, user's teams compete against other teams. In some instances a user's team competes against multiple other teams at the same time. In other instances, a user's team competes against only one other team. Also, in recent years, some fantasy sports operators have introduced offerings that allows users to draft teams and compete against computer generated teams. However, in the case of all conventional fantasy and daily fantasy sports offerings, teams play against other teams, and winners are determined based on which team(s) scores the greatest number of points during the contest duration.

Described herein is a skill-based fantasy sports wagering platform that provides a brand new way for users to participate in and wager on fantasy sports. Rather than pitting fantasy sports teams against each other, the fantasy sports wagering platform acts as the house. For each contest offered by the platform, a score “target score” is generated and published to users. For example, for NFL Week 1, the platform may generate 92.5 Fantasy Points and publish this target score to users. Users are then able to draft a fantasy football team and compete against the published score. Using the example above, if the team that the user drafts scores more than 92.5 points during Week 1 (the contest duration), the user's team is determined to have won the contest. If the user's team scores less than 92.5 points during Week 1, their team is determined to have lost the contest. In some embodiments, the performance of a user's fantasy sports team is solely dependent on the performance of their own team and has no dependence on other users' teams.

Other aspects and advantages of the invention will become apparent from the following drawings, detailed description, and claims, all of which illustrate the principles of the invention, by way of example only.

### BRIEF DESCRIPTION OF THE DRAWINGS

Certain advantages of some embodiments may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1 is a block diagram of a computer, in accordance with some embodiments.

### DETAILED DESCRIPTION

### A Platform for Fantasy Sports Competitions

Below describes a process of using the platform to draft a team and enter a contest, according to some embodiments.

The platform assigns a price (or value) to all individuals within the available pool of players. In contrast to the conventional Salary Cap format, the user may not have any fixed budget or cap for drafting their team. Rather, the platform may allow a user to draft any combination of individuals from the pool of players that he/she desires to fill out his/her team's roster. Once the user has finished drafting his/her team, the total price or value of the team is determined and then, using techniques described herein, the platform determines the probability (or odds) that the user's team will beat the “target score” and win the contest. To demonstrate this, let's assume that the platform determines that a fantasy football team that uses $50,000 worth of total value to draft their entire team for NFL Week 1 have odds of 1:1 of scoring more points that the NFL Week 1 “target score”. In this example, if the user drafts a team that has a total value that is less than $50,000, the probability of winning will be lower than a team that uses exactly $50,000 in total value, thus the odds will be longer than 1:1. If the user drafts a team that has a total value that is greater than $50,000, the probability of winning will be higher than a team that uses exactly $50,000 in total value, thus the odds will be shorter than 1:1.

An example of the platform's operation is now described.

First, the platform may present the user with a choice of contest types via a user interface, and the user may select a Contest Type. The Contest Type may be determined by the following parameters (all explained further below): Contest Duration, Schedule of Events, which will also determine the Available Player Pool (explained further below), and Stat Type. Based on the Contest Type that the user selects, he/she will be made aware of the target score for that Contest Type. From there the user will draft their team. Let's assume that the user is drafting a team for the platform's NFL Week 1 Main Event and that the target score generated for this Contest is 92.5. Now let's assume that the user drafts the following team:

| Position | Player | Cost |
|---|---|---|
| QB | Tom Brady | $7,800 |
| RB | Eddie Lacy | $6,700 |
| RB | Justin Forsett | $5,800 |
| WR | Vincent Jackson | $5,000 |
| WR | Randle Cobb | $7,500 |
| WR | Steve Smith Sr. | $6,200 |
| TE | Travis Kelce | $5,200 |
| FLEX | Doug Martin | $4,700 |
| DST | New Orleans Saints | $2,200 |

Using our previous example, let's assume that a team that uses $50,000 worth of value to fill out the entire roster would be determined by the platform to have 1:1 (or “Even”) odds of accumulating a point value greater than the NFL Week 1 “target score” of 92.5. As you can see, the team above has used a total of $51,100. Therefore, the team has slightly exceeded the $50,000 value of an Even team. As a result, in the Platform's determination, this team would be stronger than a team that used $50,000 in value so the platform would calculate odds that are shorter than 1:1.

Based on the odds that the platform generates, the platform would then determine the “Money Line” for this team. The Money Line, which is produced based (at least in part) on the odds, determines the amount of the prize that the user would stand to win if their team's score exceeds the target score for any given entry fee. For example, the Money Line for the team above may be −105 (as an example). This would mean that the user would stand to win $100 for a contest with an entry fee of $105. Note that this Money Line of −105 could be applied to determine the prize payout for any entry fee amount. Stepping away from this example for a moment, a team that used exactly $50,000 in value (using our example above) would have odds of 1:1, thus an “Even” Money Line would be produced. This would mean that the user would stand to win $100 for a contest with an entry fee of $100. Finally, a team that used $45,000 worth of value (using are example above) would have odds longer than 1:1, and a Money Line such as +120 (as an example) might be produced. This would mean that the user would stand to win $120 for a contest with an entry fee of $100.

Getting back to our example, using the lineup above, the user now has selected his/her Contest Type, drafted his/her team, and the Platform has generated and published to the user the odds and associated Money Line. Prior to taking the final step of selecting the entry fee amount that the user wants to play for, the user may have the option of adjusting the target score up or down. If the target score were to be adjusted by the user, the Platform would generate new odds and produce a new Money Line. Adjusting the target score to be higher, would produce longer odds while adjusting the target score to be lower would create shorter odds. So, let's say the user in our example that currently has a Money Line of −105 for their team wants a chance to win a greater prize if his/her team wins. This user might adjust the target score to 93.5 to get an Even Money Line (as an example) or maybe even adjust the target score to 115.5 to get a +220 Money Line (as an example). Alternatively, the user may want to give his/herself a better chance of winning, so he/she may decide to adjust the target score down to 88.5. In this case, the Platform may produce a Money Line such as −130 (as an example).

Note that the Platform may offer Contests in which the Platform has set higher (lower) “target scores” to offer larger (or smaller) payouts.

Finally, once the user has finalized all of the details of the contest he/she will select the entry fee amount that he/she wants to pay. Based on this selection, the Platform will determine and publish the potential prize payout to the user.

As can be determined from above, there are several parameters that the platform uses to determine the specifics of a contest. Below details some of these key parameters.
League: The League is the association with which the pool of players available to be drafted are members of. In the above example, all of the available players were associated with National Football League. The platform may offer Contests in which all available players are members of the same single League. The platform may offer Contests which include a pool of available players that are members of multiple different Leagues. These Leagues will not necessary be limited to sports Leagues. For example, the platform may offer contests in which individual video gamers are included in the pool of available players.
Schedule of Events: The Schedule of Events specifies which real-world events are included in the contest. The example above of the NFL Week 1 Main Event contest, included all games (or Events) on the NFL Week 1 schedule. However, some contests may only include a select number of Events. For example, the platform may offer a Contest that only includes Events that are on the Week 1 NFL schedule but that start after 4:00 pm Eastern Time. Or, only Events that are on the NFL Week 1 schedule and include NFL teams that are members of the AFC East Division.
Available Pool of Players: The League and Schedule of Events will primarily determine the Available Pool of Players eligible to be drafted for a specific Contest.
Duration: The Duration determines the timeframe in which the key performance metrics or “Stats” (e.g., Touchdowns) will be scored. Note that the Duration and the Schedule of Events for a contest will often be related. In the example above, the Duration was a full NFL game and the Schedule of Events included all games on the NFL Week 1 Schedule. However, the platform may offer contests with longer or shorter Durations. For example, the platform may offer a contest that lasts the entire NFL Regular Season. Also, the platform may offer Contests that have a Duration that is a partial game. For example, the platform may offer a contest in which stats accumulated by players on the final 9 holes of a Golf Tournament are the only stats that are scored for the Contest.
Performance Metrics (or Stats) Scored: In all examples above, there were multiple Performance Metrics (e.g., Touchdowns, Rushing Yards, etc.) that were counted to determine the user's teams Fantasy Points. However, the platform may offer Contests that only score for single stats or limited combination(s) of stats. For example, a Contest that the platform might offer is one in which the user would draft a team of 5 MLB players and in which Home Runs is the only Performance Metric scored. In this example, the platform may generate a target score such as 3.5. The user would then draft a team of 5 players. If the user's team hit more than 3.5 Home Runs during the Contest Duration, the user's team would be determined to have won the Contest. If the user's team hit less than 3.5 Home Runs, they would be determined to have lost.
Roster: The platform may offer Contests with different types of Rosters. In the example above, the Contest required the user to draft 1 QB, 2 RB, 3 WR, 1 TE, 1 FLEX, & 1 DEF. However, a Contest may include any combination of positions. For example, the platform may offer a Contest in which the user is required to draft only 1 QB, 1 RB, & 1 WR, or even a contest in which a user is required to draft only 3 QBs.
Target score: The target score may be dependent on one or more (e.g., all) of the parameters above and may be determined by the platform using techniques described herein. Some embodiments of techniques that may be used by the platform to determine the target score are described below.
Odds & Money Line: The Odds and Money Line may be dependent on one or more (e.g., all) of the variables above, and/or the exact players that the user selects to make up his/her roster. The Odds & Money Line may be determined by the platform using techniques described herein. Some embodiments of techniques that may be used by the platform to determine the Odds and Money Line are described below.

In some embodiments, the platform may determine the target score based on the user's lineup. In such embodiments, the platform may not set a target score prior to the user selecting a lineup. Rather, the user would first draft a team, and then based on the user's selected lineup, the platform would generate a fair (e.g., “even money”) target score, using the techniques described below. The user could then have the option to adjust the target score up or down as described above to manipulate the odds and associated money line.

As described above, the platform may determine the odds and/or associated money line based on the total salary of the user's lineup. Additionally or in the alternative, the platform may determine the odds and/or associated money line using the techniques described below. In some embodiments, the platform may not determine the odds and/or associated money line based on the salary of the user's lineup.

Techniques for Determining Target Score, Odds, and/or Money Line

Some embodiments of the techniques described herein may be used to generate probabilities (odds) and/or money lines for different lineups and/or score targets. In some embodiments, the platform may use these techniques to set accurate lines that are “fair” on a long-term basis.

In some embodiments, the platform uses a vigorish to enhance the platform operator's profitability over the long-run. For example, the platform may use the vigorish to ensure that the expected value of the platform operator's positions remain positive.

In some embodiments, the techniques described herein use Modern Portfolio Theory. In some embodiments, the Modern Portfolio Theory techniques rely on the assumption of a normal distribution. In some embodiments, the Modern Portfolio Theory techniques use other types of distributions, including, without limitation, lognormal distributions, binomial distributions, and/or any other distribution that acknowledges skewness and kurtosis factors.

In some embodiments, the platform may account for time risk (e.g., the risk of information that may affect the outcome of a fantasy contest being released or discovered after one or more wagers on the contest have already been placed). Such information may include, without limitation, a player's status or availability for a game in which the player can accrue points for a lineup in a contest. As a way to counter this risk, the platform may adjust the money line in real time based on the most up to date information and projections available. This approach ensures that the money lines offered by the platform are, to the extent possible, based on current information and accurate projections.

Determining Odds and Money Line:

To determine the odds of a user's lineup beating the platform's target score, the platform uses a Cumulative Distribution Function (CDF) with inputs of the projected mean average points of the user's lineup, the projected point variance of the user's lineup, and the target score. The CDF function uses those inputs to calculate the percent chance the user's lineup will beat the target score, which the platform can then use to create a money line to offer to the user.

Determining Lineup's Mean and Variance:

The platform may determine a lineup's mean and variance estimates using Modern Portfolio Theory (MPT). The inputs to the MPT process may include the mean and variance estimates of all players in the submitted lineup. In some embodiments, the inputs to the MPT process include estimated Pearson Correlation Coefficients between those players. The output of the MPT process may include specific mean and variance estimate for a fully built lineup.

Determining Pearson Correlation Coefficients:

The platform may calculate Pearson Correlation Coefficients between players using historical results. There are many dimensions on which the correlations can be calculated, including by individual players (e.g., the correlation between Tom Brady and Rob Gronkowski), by depth chart position (e.g., the correlation between WR1 and WR2), and by positions (e.g., the correlation between QB and WR). These dimensions may be further sub-divided by salary range, projections, variances, or any other metric derived from historical results. Additionally, those correlations may be calculated for teammates as well as opponents (for example, at the platform may consider how Tom Brady's performance is correlated with Rob Gronkowski's, and we also we see how Tom Brady's performance is correlated with the performance of the Colt Defense). In some embodiments, the platform may select the most precise technique for calculate Pearson Correlation Coefficients that provides a significant sample size given the available historical data.

Accurately determining the correlations between dimensions can greatly improve the accuracy of the target scores, probabilities, and/or money lines set by the platform. While more accurate dimensions (e.g., the individual player level) generally have the greatest impact on the estimates, those dimensions don't always have enough data points to achieve statistical significance. Given the relatively low number of football games during a season, the individual player dimension may fall short of being statistically significant. Furthermore, the depth chart position dimension may require multiple years of data to achieve statistical significance. In some embodiments, for NFL-based fantasy contests, the depth chart position dimension may be statistically significant and accurate when the depth chart positions are available and prevalent (e.g., RB1 and WR2), and otherwise the positions may be statistically significant and accurate (e.g., if isn't enough data to calculate a TE3 or WR5, the TE and WR aggregate positions may be used instead). Using those methods, we have made interesting observations, e.g., the observation that RB performance is positively correlated with the performance of the RB's teams' defense, and the observation that the performance of the QB and WR is negatively correlated with the performance of the QB/WR's team's defense.

Different dimensions may be used for different sports. Examples include batting orders for baseball, and starting positions for basketball.

An interesting covariance observation for baseball is that the bottom of the lineup (5-9) has very high gapped correlation (5-7, 6-8, 7-9). While people tend to only play the top of the lineup, knowing this fact can be a big help when variance is a factor.

Example Query to Calculate Covariance (based on player's position):

```
DROP TABLE IF EXISTS tmp_pos_results;
  CREATE TEMP TABLE tmp_pos_results AS
  SELECT r.year, r.week, r.game,
      p.id_player, r.team, r.opp,
      r.pos,
      f.fp, r.pts, r.pts - f.fp as diff
  FROM nfl.nfl_results_rguru r
  JOIN nfl.nfl_dim_players p
    ON p.rguru_pid = r.pid
  JOIN nfl.nfl_projs_fpros f
    ON f.year = r.year
    AND f.week = r.week
    AND f.pid = p.fpros_id
    AND f.game = CASE
      WHEN r.game = ‘dk’ then ‘draftkings’
      WHEN r.game = ‘fd’ then ‘fanduel’
      ELSE NULL END
  WHERE f.fp > 0
  AND r.pts > 0
  AND (1000.0 * f.fp / f.salary) >= {min_value}
    AND r.game in (‘dk’,‘fd’)
    AND (f.year < {year} OR (
        f.year = {year}
        AND f.week < {week})
      );
  INSERT INTO nfl.nfl_corrs_by_pos
  SELECT {year}, {week}, x.game,
    case
    when y.team = x.team then ‘team’
    when y.team = x.opp then ‘opp’
    else ‘unknown’ end as team,
    x.pos as pos1, y.pos as pos2,
    count(*) as cnt,
    corr(y.diff, x.diff) as corr
  FROM tmp_pos_results x
  JOIN tmp_pos_results y
    ON y.year = x.year
    AND y.week = x.week
    AND y.game = x.game
    AND (y.team = x.team
      OR y.team = x.opp)
    AND y.id_player <> x.id_player
  GROUP BY 3, 4, 5, 6
  HAVING COUNT(*) > 10
  ORDER BY team, pos1, pos2;
```

Determining Player's Variance:

The platform may determine a player's variance using historical results and/or historical projections. Like correlations, variance can be calculated on multiple dimensions including the individual player (variance of Tom Brady), the depth chart position (variance of WR1), and/or by the position (WR). These buckets may be subdivided by the same methods as stated above. The platform may collect the historical results for every individual player and the projections may be generated by the method described in the next section.

Determining Player's Mean:

This section describe how the platform determines point projections for individual players, according to some embodiments.

In some embodiments, the platform uses predictive models generated using statistical learning techniques. Statistical learning techniques may include, without limitation, multi-linear regressions or support vector machines. The platform may use the predictive models to generate projections for player scores. The “models” here may include a set of parameters. The statistical learning tools may be used to create the models. The inputs for these prediction models may vary greatly. For example, one model could consist of using 2 year trailing fantasy points scored, along with the 16 game point differential for the opponent team to predict a player's score each week.

In some embodiments, the platform collects projections for individual player scores (e.g., projections made by experts) and combines them together (e.g., averages the projections) to create an aggregate projection for each player.

Contest Process:

In some embodiments, a fantasy sports contest administered by the platform covers a “Week” from Tuesday-Monday Night, when the last game of a weekly NFL season occurs. As previously noted, the target score, lineup mean and variance, odds, and money line may all be calculated for longer or shorter duration contests as well (e.g., 1 single game, the last two quarters of a game, the back 9 holes of a golf tournament, etc.).

1. On a specific day at the beginning of the week (e.g., Tuesday or Wednesday), the platform generates mean and variance projections for all players that are available to draft. In some embodiments, these projections are generated only once, and therefore the platform operator incurs time risk between the time the projections are created and the time the betting is over (e.g., the start of the week's games). In some embodiments, the platform may display player “salaries” via a user interface, with those salaries being derived from a player's projected mean points.

2. Using a monte-carlo or brute-force techniques, the platform generates many lineups (e.g., millions of random lineups) and saves a certain subset (e.g., top 5%) for analysis. Using these lineups, the platform generates a target score that 50% of lineups are expected to beat. Methods to create the target score may include taking an average of the analyzed lineups, or taking the top score of the analyzed lineups and discounting it by some factor.
A. With the brute force approach, the platform calculates every possible lineup given certain restrictions. Such restrictions may include limiting the number of players that considered, salary caps, and/or salary minimums.
B. In some situations, it may not be computationally practical to analyze every possible lineup. In some embodiments, the platform relies on a Monte Carlo simulation which generates lineups with randomly assigned players until a desired number of iterations or specified time period has been met.

3. Once the target score is set, users can start drafting their lineups to compete against the target score. Once a complete lineup is entered, the platform uses the MPT algorithm to calculate the lineup's projected score and variance. Using the projected score and variance results, the platform then calculates the lineup's probability (odds) of beating the target score (e.g., by using a CDF). From those odds, the platform then calculates the money line using the money line calculation function. All of this can be done real time, and the platform can display changes in the user's money line automatically.

### Example A

At the beginning of the week, all player projections are generated and the target is calculated to be 155 Fantasy Points.

When the user creates a lineup, to the platform calculates the projected mean and variance of the lineup's score. Below is an example of an example lineup a user could create, and the projected mean and variance of each player's score and of the lineup's score:

| Pos | Name | Game | DC | Salary | Pts | Var |
|---|---|---|---|---|---|---|
| QB | Carson Palm | ARI v PIT | QB1 | 6600.0 | 22.43 | 10.06 |
| RB1 | Dion Lewis | NE vs IND | RB2 | 5800.0 | 17.00 | 14.93 |
| RB2 | Arian Foste | HOU vs JAC | RB1 | 7000.0 | 18.95 | 10.55 |
| WR1 | Larry Fitzg | ARI vs PIT | WR1 | 7000.0 | 18.94 | 12.27 |
| WR2 | DeAndre Hop | HOU vs JAC | WR1 | 7700.0 | 20.89 | 13.54 |
| WR3 | Allen Hurns | JAC vs HOU | WR2 | 5000.0 | 14.85 | 10.71 |
| TE | Jordan Came | MIA vs TEN | TE1 | 3000.0 | 9.97 | 7.47 |
| Flex | Giovani Ber | CIN vs BUF | RB2 | 4600.0 | 13.44 | 11.81 |
| DST | Packers | GB vs SD | DST | 3200.0 | 14.24 | 7.04 |
| Lineup | Target: | 150.71 | | | | |
| Lineup | Variance: | 35.01 | | | | |
| Lineup | Salary: | 49900.0 | | | | |

In this example, the lineup expected outcome is 150.71 fantasy points and its variance is 35.01. The platform then feed the target score and the lineup's projected mean and variance into the odds function which, uses those numbers to determine the probability of the user's lineup beating the target score. For this example, inserting these numbers along with the target of 155 into CDF, the platform may calculate odds of 45.12% of this lineup beating the target score. The platform then insert this probability into the money line function.

If there is no vigorish included, then the money line would be +120 (Rounded down from +121.63), meaning that the user would need to bet $100 to win $120. If the vigorish is 10%, then the line would become −130 (Rounded down from −122.81), meaning the user would need to bet $130 to win $100.

If the user wants to adjust the target score, the platform can simply re-run the odds calculation based on the new target score, and then create a new money line based on those odds. Assuming no vigorish, if the user wanted to play against a target of 140 points, the odds of them winning would be 62% which would be equivalent to a −$170 money line. If they wanted to play against 160, the odds of them winning would be 39.5%, which would be equivalent to a +$150 money line.

Money Line Function

def calculate_money_line(odds, vig=0.10, rounding=10, min_odds=0.10):
“““Returns the money line given odds and vig.
Money line is rounded to
”””
# Need a minimum odds number
odds=max([odds, min_odds])
# Easiest to get the vig is to adjust the odds
odds+=vig
# Calculate money line
if odds >0.50:
   ml=−100*odds/(1.0−odds)
else:
   ml=100*(1.0−odds)/odds
# Round it.
# If negative, floor means bets more
# If positive, floor means receive less
ml=rounding*math.floor(ml/rounding)

return ml

Odds Function

def odds(target, mean, var):
return 1.0-stats.norm.cdf(target, mean, var)
# stats.norm.cdf calculates the cumulative density function for a normal distribution, which gives the odds of a lineup reaching a certain score (target)
# The probability density function for norm is represented by: exp(−x**2/2)/sqrt(2*pi)
# The module scipy.stats may be used

Modern Portfolio Theory Function

def calculate_mpt(players, corrs):
“““Returns expected mean and stdev of the lineup given MPT”””
# Sum the projected points for each player
mu=sum([pl.pts for pl in players])
# Calculate the variance of the portfolio
var=0
for pl1 in players:
   for pl2 in players:
      var=var+(pl1.std*pl2.std*get_corr(pl1, pl2, corrs))
# Standard deviation is the square root of variance
sigma=np.sqrt(var)
return mu, sigma

Expected return: E(Rₚ)=Σᵢwi E(Ri)

Portfolio return variance: σₚ²=ΣᵢΣⱼ wi wj σi σj pij

Calculating Portfolio Risk using MPT

A portfolio in this context may include any collection of lineups. For the purpose of this platform, a portfolio could represent all lineups placed as bets for an event. A modified MPT can be used to calculate the covariance between different lineups:

def calculate_lineup_covariance(lineup1, lineup2, corrs):

var=0

for pl1 in lineup1.players:

for pl2 in lineup2.players;
var=var+(pl1.std*pl2.std*get_corr(pl1, pl2, corrs))

return var

Furthermore, the platform can calculate the actual expected monetary return of a lineup given the payout structure of the bet. For this platform, the payout structure would consist of the target and money line/odds given (e.g., for a target of 160 and money line of +150, the payout structure {target=160, odds=150}, the user would win 150% of the bet if the user's score reaches the target. The following function demonstrates how to use a lineup's predicted mean and variance along with the payout structure to determine its expected monetary return.

def get_pay(lineup, payouts):

“““Calculates the expected return and standard dev

of a lineup given a tournaments payout structure”””

payouts=np.array(payouts)

payouts. sort(axis=0) # Sort payouts

payouts=payouts[::−1] # Reverse to get highest payout at top

pts, var=lineup.get_dist( )

# Iterate over payouts to see what % of time we reach each of them

prev_win=0

rets=[ ]

for payout in payouts:
target, pay=payout
z=(target-pts)/np.sqrt(var)
raw_win=1.0-stats.norm.cdf(z) # % of time we reach this level
win=raw_win −prev_win # Minus % of time we reached higher level
# Save the level we have reached with this payout
# To deduct it from other payouts
prev_win=raw_win
# Add to our return
rets.append([win, pay])

# Append the possibility of losing

rets.append([1.0-prev_win, 0.])

ret_avg=sum([r[0]*r[1] for r in rets])−1.0 # Take out the entry fee

ret_var=sum([r[0]*(r[1]-ret_avg)**2 for r in rets])

return ret_avg, ret_var

Using this covariance, along with the projected monetary return and variance of the lineups, the platform can calculate the overall risk of a portfolio of lineups.

### Further Description of Some Embodiments

Some embodiments of the methods and operations described in the present disclosure can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on a computer storage medium for execution by, or to control the operation of, data processing apparatus.

Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

Some embodiments of the methods and operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, for example web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Some embodiments of the processes and logic flows described in this specification can be performed by one or more programmable processors executing one or more computer programs to perform actions by operating on input data and generating output. Some embodiments of the processes and logic flows described herein can be performed by, and some embodiments of the apparatus described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both.

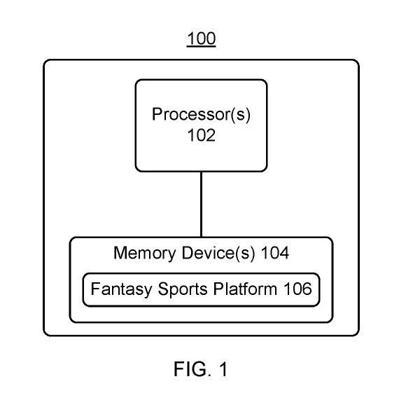

FIG. 1 shows a block diagram of a computer 100. The elements of the computer 100 include one or more processors 102 for performing actions in accordance with instructions and one or more memory devices 104 for storing instructions and data. In some embodiments, the computer 100 executes a fantasy sports platform 106. Different versions of the fantasy sports platform 106 may be stored, distributed, or installed. Some versions of the software may implement only some embodiments of the methods described herein.

Generally, a computer 100 will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Some embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations may be described in this disclosure or depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying FIGURES do not necessarily require the particular order shown, or sequential order, to achieve desirable results. In certain implementations, multitasking and parallel processing may be advantageous.

### TERMINOLOGY

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

### EQUIVALENTS

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method of administering a fantasy sports contest, comprising:
obtaining a target score for the fantasy sports contest;
identifying a prize corresponding to the target score;
receiving input specifying a lineup of a fantasy sports team of a participant in the fantasy sports contest;
determining an actual score of the lineup of the participant's team;
determining whether the actual score of the participant's lineup exceeds the target score, and if the actual score of the participant's lineup exceeds the target score, providing an indication that the prize has been awarded to the participant,
wherein the target score depends on statistical measures and/or probability distributions of predicted scores of one or more lineups eligible for the fantasy sports contest, or a value of the prize depends on statistical measures and/or a probability distribution of a predicted score of the lineup of the participant's team.

2. The method of claim 1, wherein obtaining the target score comprises determining the target score based on statistical measures and/or probability distributions of predicted scores of one or more lineups eligible for the fantasy sports contest.

3. The method of claim 2, wherein the target score is determined before the input specifying the lineup of the participant's team is received.

4. The method of claim 3, wherein determining the target score comprises performing a Monte Carlo analysis of predicted scores of the one or more eligible lineups.

5. The method of claim 4, wherein a value of a team strength metric for each of the eligible lineups is not greater than a specified value of the team strength metric.

6. The method of claim 5, further comprising:
receiving input specifying a lineup of a fantasy sports team of a prospective participant in the fantasy sports contest;
determining a value of the team strength metric for the prospective participant's team based on the lineup of the prospective participant's team;
determining that the value of the team strength metric for the prospective participant's team is greater than the specified value of the team strength metric; and
based on the determination that the value of the team strength metric for the prospective participant's team is greater than the specified value of the team strength metric, determining that the prospective participant's team is ineligible for the contest and prohibiting the prospective participant's team from participating in the fantasy sports contest.

7. The method of claim 5, further comprising, prior to determining the actual score of the participant's team:
determining a value of the team strength metric for the participant's team based on the lineup of the participant's team;
determining that the value of the team strength metric for the participant's team is not greater than the specified value of the team strength metric; and
based on the determination that the value of the team strength metric for the participant's team is not greater than the specified value of the team strength metric, determining that the prospective participant's team is eligible for the contest and permitting the participant's team to participate in the fantasy sports contest.

8. The method of claim 2, wherein the target score is determined after the input specifying the lineup of the participant's team is received.

9. The method of claim 8, wherein the one or more eligible lineups comprise the lineup of the participant's team, and wherein determining the target score comprises:
determining, based on statistical measures and/or the probability distribution of the predicted score of the lineup of the participant's team, a probability of the actual score of the lineup of the participant's team exceeding a specified score; and
determining the target score based on the probability of the actual score of the lineup of the participant's team exceeding the specified score.

10. The method of claim 1, further comprising:
determining, based on statistical measures and/or the probability distribution of the predicted score of the lineup of the participant's team, a probability of the actual score of the lineup of the participant's team exceeding a specified score; and
determining the value of the prize based on the probability of the actual score of the lineup of the participant's team exceeding the specified score.

11. The method of claim 10, wherein the specified score is the target score.

12. The method of claim 1, further comprising determining a value of a team strength metric for the participant's team.

13. The method of claim 12, further comprising:
determining the value of the prize based on the value of the team strength metric for the participant's team.

14. A predictive modeling apparatus comprising:
a memory configured to store processor-executable instructions; and
a processor configured to execute the processor-executable instructions, wherein executing the processor-executable instructions causes the apparatus to perform steps including:
obtaining a target score for the fantasy sports contest;
identifying a prize corresponding to the target score;
receiving input specifying a lineup of a fantasy sports team of a participant in the fantasy sports contest;
determining an actual score of the lineup of the participant's team;
determining whether the actual score of the participant's lineup exceeds the target score, and if the actual score of the participant's lineup exceeds the target score, providing an indication that the prize has been awarded to the participant,
wherein the target score depends on statistical measures and/or probability distributions of predicted scores of one or more lineups eligible for the fantasy sports contest, or a value of the prize depends on statistical measures and/or a probability distribution of a predicted score of the lineup of the participant's team.

15. An article of manufacture having computer-readable instructions stored thereon that, when executed by a processor, cause the processor to perform operations including:
obtaining a target score for the fantasy sports contest;
identifying a prize corresponding to the target score;
receiving input specifying a lineup of a fantasy sports team of a participant in the fantasy sports contest;
determining an actual score of the lineup of the participant's team;
determining whether the actual score of the participant's lineup exceeds the target score, and if the actual score of the participant's lineup exceeds the target score, providing an indication that the prize has been awarded to the participant,
wherein the target score depends on statistical measures and/or probability distributions of predicted scores of one or more lineups eligible for the fantasy sports contest, or a value of the prize depends on statistical measures and/or a probability distribution of a predicted score of the lineup of the participant's team.
